(19) United States
(12) Patent Application Publication
(10) Pub. No.: US 2005/0075117 A1
(43) Pub. Date: Apr. 7, 2005

(54) System and method for preventing to use portable terminal having camera as secret spy camera

(76) Inventor: Chul-Ho Jang, Ichon-shi (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/749,351

(22) Filed: Dec. 30, 2003

(30) Foreign Application Priority Data
Sep. 23, 2003 (KR) 2003-65789

(51) Int. Cl. H04Q 7/20; H04M 1/00

(52) U.S. Cl. 455/456.4; 455/556.1

(57) ABSTRACT

Disclosed is a secret spy camera prevention system and method, in which a portable terminal having a camera module can be prevented from being used as a secret spy camera. The secret spy camera prevention system including: a terminal for stopping an operation of the camera module mounted therein if the restriction signal transmitted to the photographing-prohibited place is inputted thereto.

### FIELD OF THE INVENTION

The present invention relates to a system and method for preventing a portable terminal having a camera from being used as a secret spy camera.

### DESCRIPTION OF THE PRIOR ART

FIG. 1 is a block diagram illustrating a conventional secret spy camera detecting portable terminal.

The portable terminal includes a power supply unit 110 for supplying a power supply thereto; a mode selecting unit 120 for selecting one of a proper function and a detection function thereof; a portable-phone function unit 130 for operating depending on a selection of the mode selecting unit 120; a detecting unit 140 for performing a detection function; a controller 150 for controlling all operations of the detecting unit 140; a display 160 for operating under a control of the controller 150; and an alarming unit 170 for performing a bell or vibration operation to inform a user when a telephone is called or when the detecting unit 140 detects the secret spy camera.

The secret spy camera is a small and portable camera which can be easily hided for taking picture or moving images unauthorized scene. The secret spy camera is known as hidden camera or secret camera.

However, the conventional secret spy camera detecting portable terminal has a drawback in that a user is just only informed of whether or not the secret spy camera exists, the secret spy camera cannot be fundamentally prevented from being used to take a photograph.

### SUMMARY OF THE INVENTION

It is, therefore, an object of the present invention to provide a system and method for preventing a secret spy camera in which a radio frequency identification (RFID) module is used to pause the camera function of a portable terminal under a control of a controller of the portable terminal such that the camera function can be automatically limited at a specific place to prevent illegal photographing.

In accordance with one aspect of the present invention, there is provided a system for preventing a portable terminal having a camera installed from being used as a secret spy camera, the system including: a portable terminal having a camera module; and a reader installed at a photographing-prohibited place, for transmitting a prohibit signal to limit a camera operation of the portable terminal.

In accordance with another aspect of the present invention, there is provided a system for preventing a portable terminal having a camera from being used as a secret spy camera, the system including: a remote reader generating a restriction signal as the prohibit signal having a frequency band that is sensed within the photographing-prohibited place.

In accordance with another aspect of the present invention, there is provided a system for preventing a portable terminal having a camera from being used as a secret spy camera, the system including: an adjacent reader installed at a boundary of a photographing-prohibited place, for outputting a restriction signal as the prohibit signal for limiting a camera operation of a terminal having a camera module, and a release signal for releasing a limitation of the camera operation caused by the restriction signal.

In accordance with a further another aspect of the present invention, there is provided a method for preventing a portable terminal having a camera from being used as a secret spy camera, the method including the steps of: a) limiting an operation of a camera unit within a terminal by sensing a prohibit signal.

In accordance with a still further another aspect of the present invention, there is provided a method for preventing a portable terminal having a camera from being used as a secret spy camera, the method including the steps of: a-i) determining whether or not a restriction signal as the prohibit signal is sensed and a-ii) in case the restriction signal is sensed, limiting an operation of a camera unit within a terminal, and then returning to the step a-i).

In accordance with a still further another aspect of the present invention, there is provided a method for preventing a portable terminal having a camera from being used as a secret spy camera, the method including the steps of: a-1) determining whether or not a terminal enters into a photographing-prohibited place by determining whether or not a restriction signal is sensed, and if the restriction signal is not sensed, continuing to determine whether or not the restriction signal is sensed; a-2) in case the restriction signal is sensed, limiting an operation of a camera unit within a terminal, and then returning to the step a-1); a-3) determining whether or not the terminal exits from the photographing-prohibited place by sensing the release signal, and if the release signal is not sensed, continuing to determining whether or not the release signal is sensed; and a-4) in case the release signal is sensed, restoring the operation of the camera unit within the terminal, and then returning to the step a-1).

### BRIEF DESCRIPTION OF THE DRAWINGS

The above and other objects and features of the present invention will become apparent from the following description of the preferred embodiments given in conjunction with the accompanying drawings, in which:

FIG. 1 is a block diagram of a conventional secret spy camera detecting portable terminal;

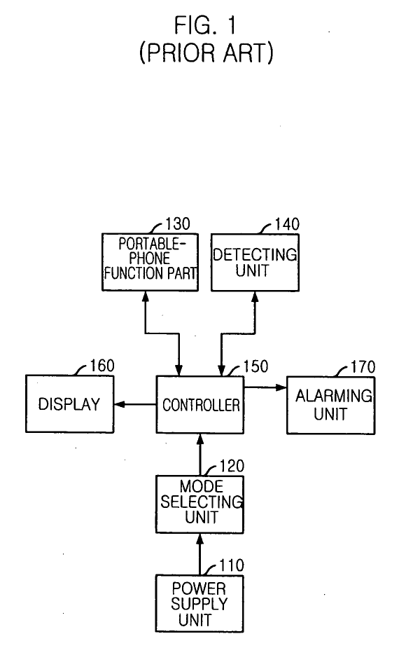

FIG. 2 is a block diagram of a system for preventing a portable terminal having a camera from being used as a secret spy camera in accordance with one embodiment of the present invention;

FIG. 3 is a block diagram of a system for preventing a portable terminal having a camera from being used as a secret spy camera in accordance with another embodiment of the present invention;

FIG. 4 is a flowchart of a method for preventing a portable terminal having a camera from being used as a secret spy camera in accordance with one embodiment of the present invention; and

FIG. 5 is a flowchart illustrating a method for preventing a portable terminal having a camera from being used as a secret spy camera in accordance with another embodiment of the present invention.

### DETAILED DESCRIPTION OF THE PREFERRED EMBODIMENTS

Reference will now be made in detail to the preferred embodiments of the present invention, examples of which are illustrated in the accompanying drawings.

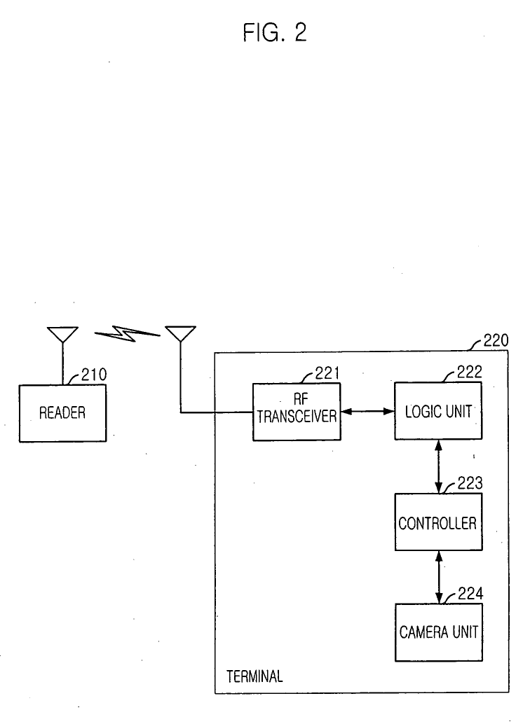

FIG. 2 is a block diagram illustrating a system for preventing a portable terminal having a camera from being used as a secret spy camera in accordance with one embodiment of the present invention.

The system includes a remote reader 210 and a terminal 220.

The remote reader 210 transmits a restriction signal. Herein, it is desirable that the restriction signal has a high frequency band because the high frequency band has a wide detection distance as shown in Table 1.

TABLE 1

| Frequency Band | Recognition distance |
|---|---|
| Low frequency band | Short distance (below 1.8 m) |
| (100 kHz-500 kHz) | |
| Intermediate frequency band | Middle recognition distance |
| (10 MHz-15 MHz) | |
| High frequency band | Long distance (to 27 m) |
| (860 MHz-930 MHz, 2.4 GHz-5.8 GHz) | |

The remote reader 210 is installed at a bathroom, a dressing room or a photographing-prohibited secret place to control the terminal 220 having the camera module to be described later. Further, the restriction signal is transmitted at a first time interval (T1), and the first time interval (T1) is adjusted corresponding to a second time interval (T2) to be described later.

Further, if the terminal 220 receives the restriction signal from the remote reader 210, an operation of the camera module installed in the terminal is stopped. In the below, the terminal 220 will be described in detail.

A radio frequency (RF) transceiving unit 221 mounted within the terminal 220 receives the restriction signal from the remote reader 210.

Further, if a logic unit 222 mounted within the terminal 220 recognizes the restriction signal received from the RF transceiving unit 221, a restriction-area recognizing signal is generated and outputted to a controller 223 to be described later. If the logic unit 222 does not recognize the restriction signal while the restriction-area recognizing signal is generated, a restriction-area releasing signal is generated and outputted to the controller 223 to be described later. Herein, if the restriction signal is not recognized during the second time interval (T2), the restriction-area releasing signal is generated. The second time interval (T2) should be set to a time longer than the first time interval (T1).

In the meanwhile, if the controller 223 mounted within the terminal 220 receives the restriction-area recognizing signal from the logic unit 222, a control operation is performed to limit the camera function of a camera unit 224 to be described later. If the controller 223 receives the restriction-area releasing signal from the logic unit 222, the control operation is performed to enable the camera function of the camera unit 224 according to a user's selection, which will be described later.

Further, the camera unit 224 mounted within the terminal 220 performs a photographing operation under a control of the controller 223.

An operation of the system for preventing a portable terminal having a camera from being used as a secret spy camera in accordance with one embodiment of the present invention will be described in the following.

First, if a terminal user enters into a bath room, a dressing room or a photographing-prohibited secret place to which the remote reader 210 in advance installed transmits the restriction signal at a certain interval, the logic unit 222 mounted within the terminal 220 recognizes the restriction signal inputted through the RF transceiving unit 221. After that, if the logic unit 222 generates the restriction-area recognizing signal and the controller 223 receives the restriction-area recognizing signal, the operation of the camera unit 224 is limited.

In the meantime, if the terminal user enters into a general area at which the remote reader 210 is not installed, the logic unit 222 mounted within the terminal 220 no longer recognizes the restriction signal. After that, if the logic unit 222 generates the restriction-area releasing signal and the controller 223 receives the restriction-area releasing signal, the operation of the camera unit 224 is restored to a normal state.

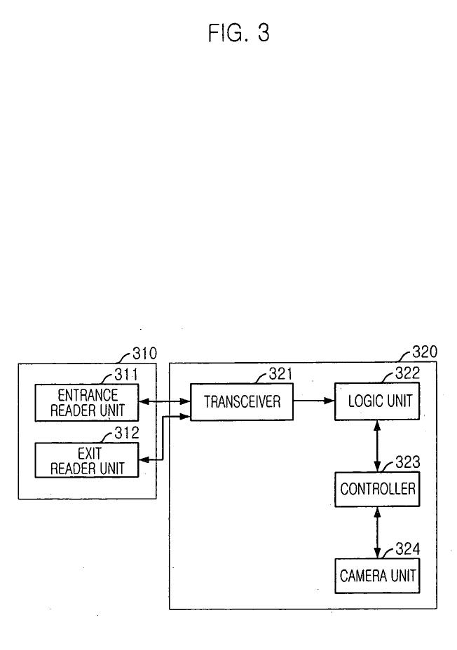

FIG. 3 is a block diagram illustrating a system for preventing a portable terminal having a camera from being used as a secret spy camera in accordance with another embodiment of the present invention.

The system includes an adjacent reader 310 and a terminal 320.

The adjacent reader 310 outputs a restriction signal and a release signal. The adjacent reader 310 is installed at a bathroom, a dressing room or a photographing-prohibited secret place to control a terminal 320 having a camera module to be described later. Herein, the adjacent reader 310 is described as follows.

An entrance reader unit 311 mounted within the adjacent reader 310 is installed at entrances of the bathroom, the dressing room or the photographing-prohibited secret place to output the restriction signal.

Further, an exit reader unit 312 mounted within the adjacent reader 310 is installed at exits of the bathroom, the dressing room or the photographing-prohibited secret place to output the release signal.

Furthermore, the terminal 320 is adjacent to the adjacent reader 310 to receive the restriction signal or the release signal. If the terminal 320 receives the restriction signal, the operation of the camera module mounted therein is stopped, and if the terminal 320 receives the release signal, the operation of the camera module mounted therein is restored. Herein, the terminal 230 is described in detail as follows.

A transceiving unit 321 mounted within the terminal 320 receives and transmits the restriction signal and the release signal outputted from the adjacent reader 310.

Further, if the logic unit 322 mounted within the terminal 320 recognizes the restriction signal received from the transceiving unit 321, a restriction-area recognizing signal is generated and outputted to a controller 323, which will be described later, and if the logic unit 322 recognizes the release signal, the restriction-area releasing signal is generated and outputted to the controller 323 to be described later.

On the other hand, if the controller 323 mounted within the terminal 320 receives the restriction-area recognizing signal from the logic unit 322, a control operation is performed to limit a camera function of a camera unit 324, which will be described later. If the controller 323 receives the restriction-area releasing signal from the logic unit 322, the control operation is performed to enable the camera function of the camera unit 324 according to the user's selection, which will be later.

Further, the camera unit 324 mounted within the terminal 320 performs a photographing operation under the control of the controller 323.

An operation of the above-described system for preventing a portable terminal having a camera being used as a secret spy camera in accordance with another embodiment of the present invention is described as follows.

First, if the terminal user enters into the bathroom, the dressing room or the photographing-prohibited secret place through the entrance port having the entrance reader unit 311 installed thereat, the logic unit 322 mounted within the terminal 320 recognizes the restriction signal inputted through the transceiving unit 321. After that, if the logic unit 322 generates and inputs the restriction-area recognizing signal to the controller 323, the operation of the camera unit 324 is limited.

In the meantime, if the terminal user exits to a general area through the exit port having the exit reader unit 312 installed thereat, the logic unit 322 mounted within the terminal 320 recognizes the release signal. After that, if the logic unit 322 generates and inputs the restriction-area releasing signal to the controller 323, the operation of the camera unit 324 is restored to the normal state.

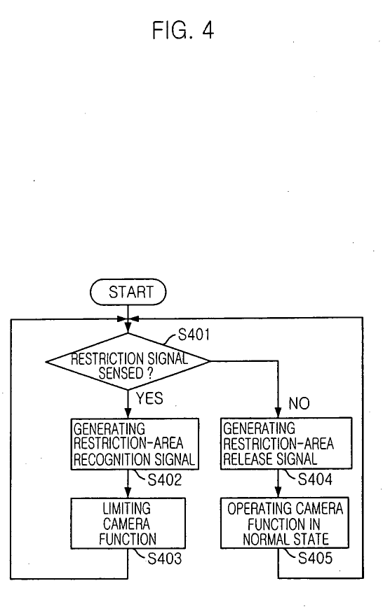

FIG. 4 is a flowchart illustrating a method for preventing a portable terminal having a camera being used as a secret spy camera in accordance with one embodiment of the present invention, and a description therefore is as follows.

First, it is determined whether or not the restriction signal is sensed at step S401. That is, at step S401, it is determined whether or not the user of the terminal enters a photographing-prohibited secret place such as the bathroom or the dressing room by receiving a restriction signal transmitted from the remote reader 210 previously installed.

After that, in case the restriction signal is sensed, the logic unit 222 of the terminal 220 recognizes the restriction signal received through the RF transceiving unit 221, and generates the restriction-area recognizing signal at step S402.

Next, if the restriction-area recognizing signal is inputted to the controller 223, the controller 223 controls to limit the operation of the camera unit 224, and then returns to the step S401 for determining whether or not the restriction signal is sensed at step S403.

On the other hand, in case the restriction signal is not sensed, the logic unit 222 generates the restriction-area releasing signal at step S404. That is, a predetermined time is passed without sensing the restriction signal, the restriction-area releasing signal is generated. The predetermined time is preset as the second time interval T2 and it must be longer than the first time interval T1 being a transmission interval of the restriction signal.

After that, if the restriction-area releasing signal is inputted to the controller 223, the controller 223 controls to restore the operation of the camera unit 224 to the normal state at step 405 and it returns to the step S401 for determining whether or not the restriction signal is sensed.

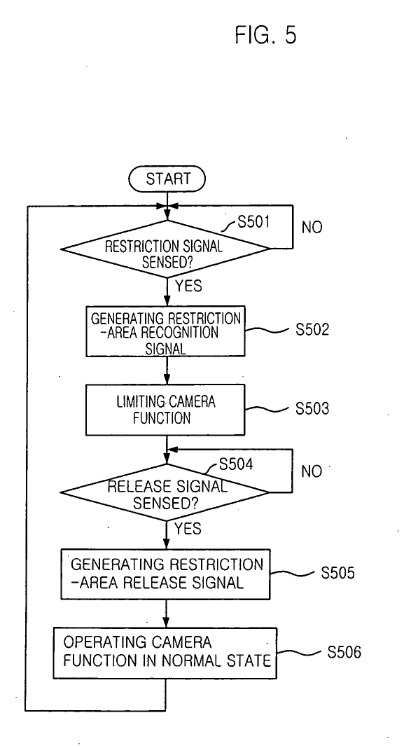

FIG. 5 is a flow chart illustrating a method for preventing a portable terminal having a camera from being used as a secret spy camera in accordance with another embodiment of the present invention.

First, it is determined whether or not the restriction signal is sensed at step S501. That is, it is determined whether or not the terminal user enters into the photographing-prohibited secret place such as the bathroom or the dressing room by receiving the restriction signal transmitted from the entrance reader unit 311 previously installed. In case the restriction signal is not sensed, it continuously determines whether or not the restriction signal is sensed at step S501.

After that, in case the restrictions signal is sensed, the logic unit 322 of the terminal 320 recognizes the restriction signal inputted through the RF transceiving unit 321, and the logic unit 322 generates the restriction-area recognizing signal at step S502.

Next, if the restriction-area recognizing signal is inputted to the controller 323, the controller 323 controls to limit the operation of the camera unit 324 at step 503.

After limiting the operation of the camera unit, it is determined whether or not the release signal is sensed at step S504. That is, it is determined whether or not the terminal user exits from the photographing-prohibited secret place such as the bathroom or the dressing room by sensing the release signal at step S504. In case the release signal is not sensed, it is continuously determined whether or not the release signal is sensed at step S504.

However, in case the release signal is sensed, the restriction-area releasing signal is generated from the logic unit 322 at step S505.

When the release signal is sensed, the restriction-are releasing signal is inputted to the controller 323 and the controller 323 controls to restore the operation of the camera unit 324 to the normal state at step 506. After restoring the operation of the camera unit 324 to the normal state, it returns to the step S501 for determining whether or not the restriction signal is sensed.

As described above, the present invention has an advantage in that the RFID (Radio Frequency Identification) module is used to pause the camera function under the control of the controller of the portable terminal such that the camera function is automatically limited at the specific place to prevent the illegal photographing.

While the present invention has been described with respect to the particular embodiments, it will be apparent to those skilled in the art that various changes and modifications may be made without departing from the scope of the invention as defined in the following claims.

1. A system for preventing a portable terminal having a camera installed from being used as a secret spy camera, the system comprising:
a portable terminal having a camera module; and
a reader installed at a photographing-prohibited place, for transmitting a prohibit signal to limit a camera operation of the portable terminal.

2. The system as recited in claim 1, wherein the reader is a remote reader generating a restriction signal as the prohibit signal having a frequency band that is sensed within the photographing-prohibited place.

3. The system as recited in claim 1, wherein the reader is an adjacent reader installed at a boundary of a photographing-prohibited place, for outputting a restriction signal as the prohibit signal for limiting a camera operation of a terminal having a camera module, and a release signal for releasing a limitation of the camera operation caused by the restriction signal.

4. The system as recited in claim 3, wherein the adjacent reader includes:
an entrance reader unit installed at an entrance port of the photographing-prohibited place, for outputting the restriction signal; and
an exit reader unit installed at an exit port of the photographing-prohibited place, for outputting the release signal.

5. A system for preventing a portable terminal having a camera installed from being used as a secret spy camera, the system comprising:
a terminal for limiting an operation of a camera module mounted therein by receiving a prohibit signal transmitted from a photographing-prohibited place.

6. The system as recited in claim 5, wherein the terminal stops an operation of the camera module if a restriction signal transmitted from the photographing-prohibited place is inputted to the terminal.

7. The system as recited in claim 6, wherein the terminal includes:
a radio frequency (RF) transceiver for receiving the restriction signal;
a logic unit for generating a restriction-area recognizing signal if the restriction signal is recognized, and generating a restriction-area releasing signal if the restriction signal is not recognized while the restriction-area recognizing signal is generated;
a controller for performing a control operation to restrict a camera function if the restriction-area recognizing signal is inputted to the terminal, and for releasing a limitation of the camera function if the restriction-area releasing signal is inputted to the terminal; and
a camera unit for performing a photographing operation under a control of the controller.

8. The system as recited in claim 5, wherein the terminal receives a restriction signal or a release signal sensed by an adjacent operation, and stops an operation of the camera module installed therein if the restriction signal is received, and restoring an operation of the camera module installed therein if the release signal is received.

9. The system as recited in claim 8, wherein the terminal includes:
a transceiving unit for receiving and transmitting the restriction signal and the release signal;
a logic unit for generating a restriction-area recognizing signal if the restriction signal is recognized, and generating a restriction-area releasing signal if the release signal is recognized;
a controller for performing a control operation for limiting a camera function if the restriction-area recognizing signal is received, and releasing a limitation of the camera function if the restriction-area releasing signal is received; and
a camera unit for performing a photographing operation under a control of the controller.

10. A method for preventing a portable terminal having a camera installed from being used as a secret spy camera, the method comprising the steps of:
a) limiting an operation of a camera unit within a terminal by sensing a prohibit signal.

11. The method as recited in claim 10, wherein the step a) includes the steps of:
a-i) determining whether or not a restriction signal as the prohibit signal is sensed and
a-ii) in case the restriction signal is sensed, limiting an operation of a camera unit within a terminal, and then returning to the step a-i).

12. The method as recited in claim 11, further includes the steps of:
a-iii) in case the restriction signal is not sensed during a time longer than a transmission interval of the restriction signal, restoring the operation of the camera unit within the terminal to a normal state, and then returning to the step a-i).

13. The method as recited in claim 10, wherein the step a) furthering includes the steps of:
a-1) determining whether or not a terminal enters into a photographing-prohibited place by sensing a restriction signal, and if the restriction signal is not sensed, continuing to determine whether or not the restriction signal is sensed;
a-2) in case the restriction signal is sensed, limiting an operation of a camera unit within a terminal, and then returning to the step a-1);
a-3) determining whether or not the terminal exits from the photographing-prohibited place by sensing the release signal, and if the release signal is not sensed, continuing to determining whether or not the release signal is sensed; and
a-4) in case the release signal is sensed, restoring the operation of the camera unit within the terminal, and then returning to the step a-1).
